(19) United States
(12) Patent Application Publication
(10) Pub. No.: US 2003/0073558 A1
(43) Pub. Date: Apr. 17, 2003

(54) Machine and method for converting paper stock into dunnage

(76) Inventors: Bill Chesterson, Richboro, PA (US); John Greenewald, Burlington, NJ (US); Thomas Lawton, Newtown, PA (US)

Correspondence Address: DORSEY & WHITNEY LLP, Suite 3400, Four Embarcadero Center, San Francisco, CA, 94111-4187, US

(21) Appl. No.: 10/229,270

(22) Filed: Aug. 26, 2002

Related U.S. Application Data
(60) Provisional application No. 60/329,484, filed on Oct. 15, 2001.

(51) Int. Cl. B31F 5/02; G03B 1/04

(52) U.S. Cl. 493/250; 242/350

(57) ABSTRACT

Machine and method for converting paper stock to cushioning material or dunnage in which paper is withdrawn from a supply, passed about an arcuately curved forming bar to impart a lateral curvature to the paper, and then passed between confronting surfaces of feed belts to crumple the curved paper and thereby form the cushioning material, after which the crumpled paper or cushioning material is cut to desired lengths with a knife blade. Operation of both the feed belts and the knife blade is controlled by a foot switch, logic circuitry, and a limit switch which monitors the position of the blade. Depressing the foot switch causes the feed belts to advance, and releasing it causes the belts to stop and the knife blade to advance.

### BACKGROUND OF THE INVENTION

1. Field of Invention

This invention pertains generally to paper dispensing devices and, more particularly, to a machine and method for converting paper stock into dunnage.

2. Related Art

When a product or item is shipped from one location to another, it is typically placed in a protective enclosure, such as a cardboard box. If the item does not conform to the shape of the box, voids between the item and the box are commonly filled with dunnage material to cushion the item and to prevent it from moving about within the box during shipment. Conventional fill materials include loose fill packing materials, plastic bubble wrap, air-filled bags, expandable foam, and crumpled paper. The bubble wrap and expanded foam are difficult to recycle and create environmental problems if disposed of. Crumpled paper is relatively easy to recycle, but the machines for forming it can be economically infeasible for small establishments or individuals. Moreover, such machines take up valuable floor space that could be used for other purposes.

### OBJECTS AND SUMMARY OF THE INVENTION

It is, in general, an object of the invention to provide a new and improved machine and method for converting paper stock into cushioning material or dunnage.

Another object of the invention is to provide a machine and method of the above character which are simpler and less expensive than dunnage making equipment heretofore provided.

Another object of the invention is to provide a machine and method of the above character which can be employed on a bench or tabletop.

These and other objects are achieved in accordance with the invention by providing a machine and method in which paper is withdrawn from a supply, passed about an arcuately curved forming bar to impart a lateral curvature to the paper, and then passed between confronting surfaces of feed belts to crumple the curved paper and thereby form the cushioning material, after which the crumpled paper or cushioning material is cut to desired lengths with a knife blade. Operation of both the feed belts and the knife blade is controlled by a foot switch, logic circuitry, and a limit switch which monitors the position of the blade. Depressing the foot switch causes the feed belts to advance, and releasing it causes the belts to stop and the knife blade to advance.

### BRIEF DESCRIPTION OF THE DRAWINGS

FIG. 1 is a perspective view of one embodiment of a dunnage machine for converting paper stock into dunnage material in accordance with the invention.

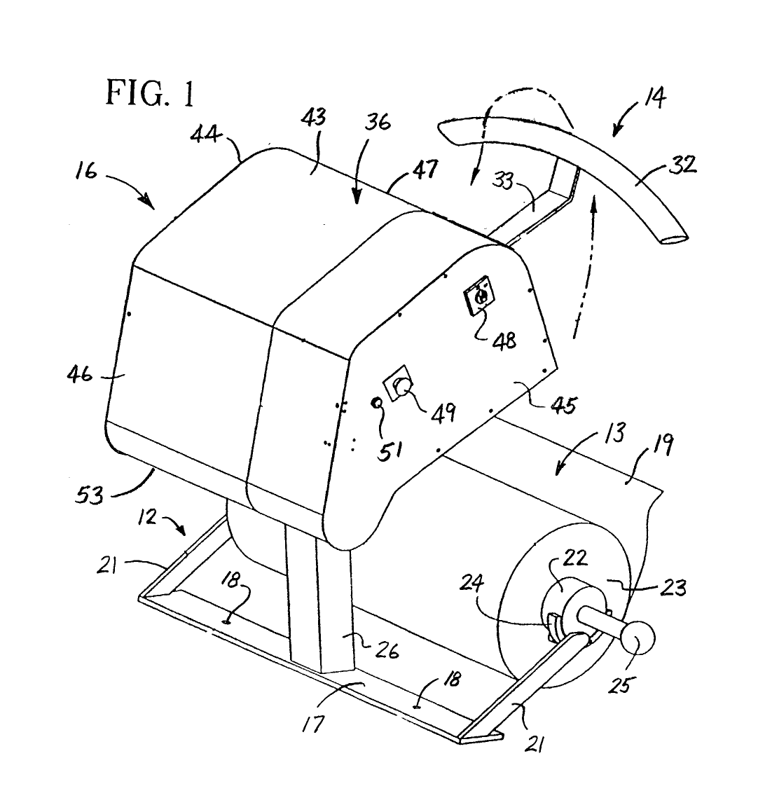

FIG. 2 is an enlarged perspective view of a portion of the embodiment of FIG. 1, with the cover removed from the machine.

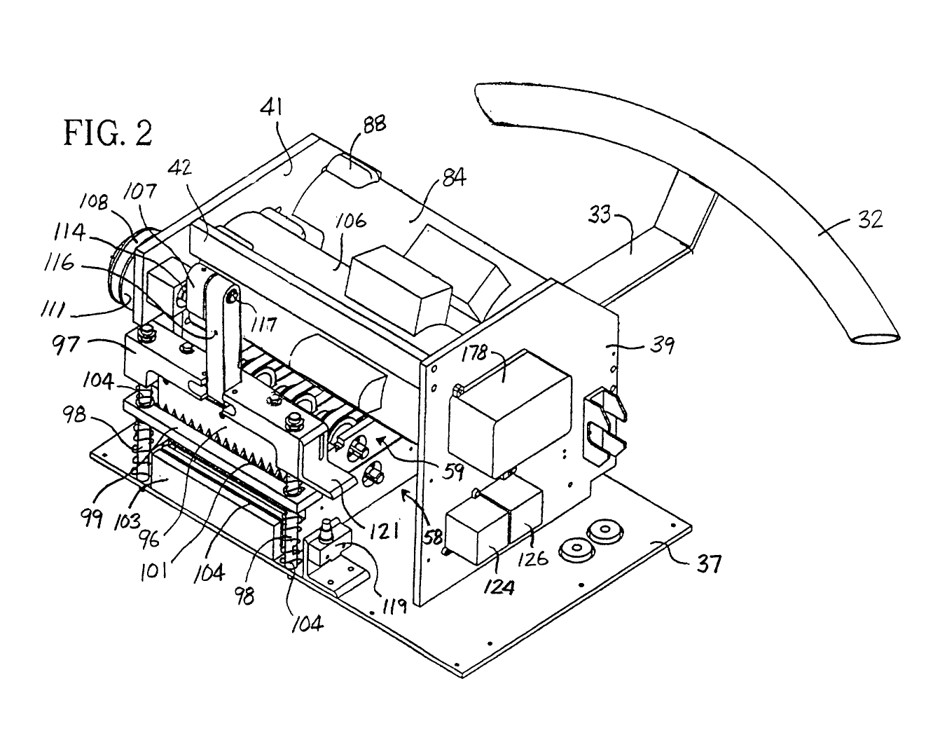

FIG. 3 is a left side elevational view of the embodiment of FIG. 1.

FIG. 4 is an isometric view of the folding and feeding mechanism of the paper crumpling head in the embodiment of FIG. 1.

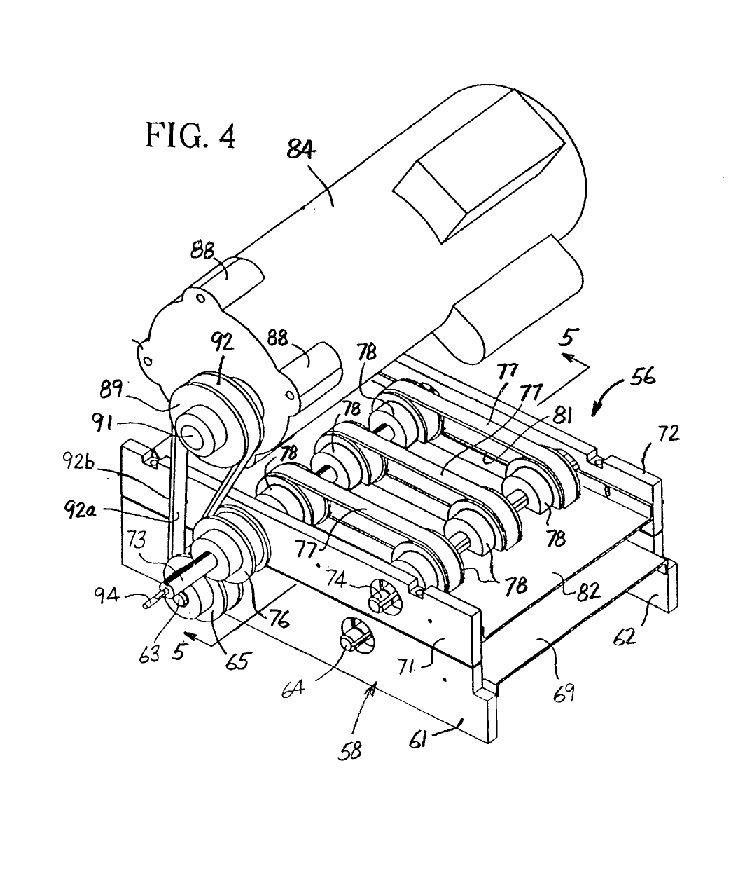

FIG. 5 is a cross-sectional view taken in the direction indicated by line 5-5 in FIG. 4.

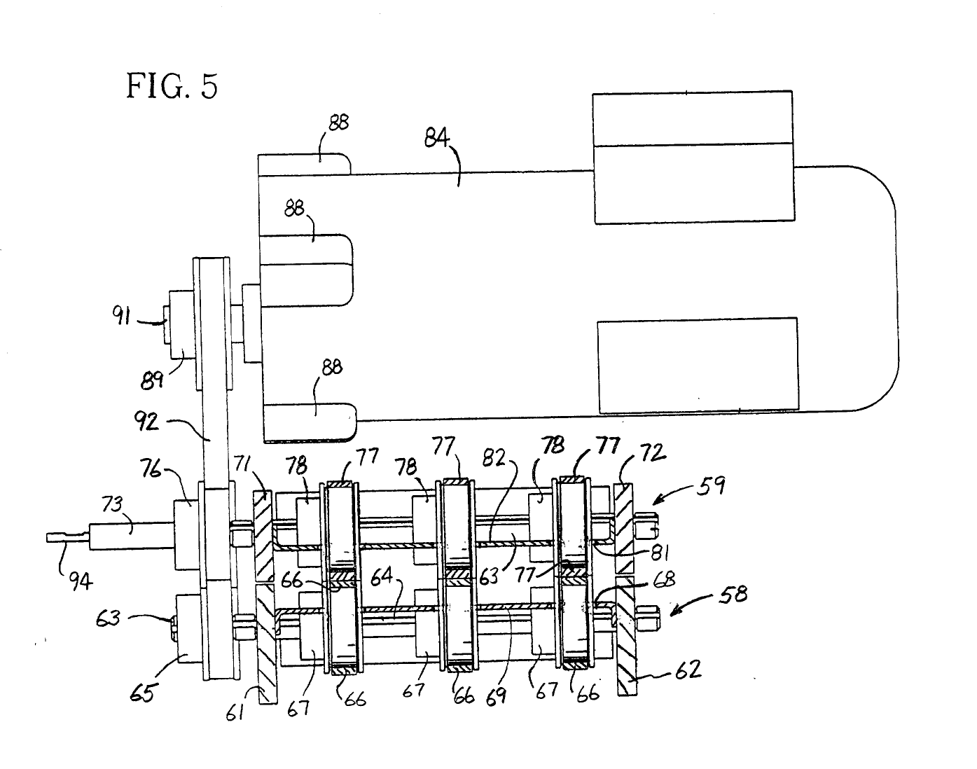

FIG. 6 is a simplified block diagram of the control system in the embodiment of FIG. 1.

### DETAILED DESCRIPTION

As shown in the drawings, the dunnage machine includes a mounting base 12 which supports a paper supply 13, a paper forming or shaping unit 14, and a crumpling head 16.

The mounting base includes a generally flat base plate or bar 17 with mounting holes 18 for receiving screws or other fasteners (not shown) to secure the machine to a mounting surface such as a tabletop or bench, or other suitable surface. Although the dunnage machine is shown as being oriented for mounting on a horizontal surface, it will be understood that the machine can also be mounted on vertical or inclined surfaces, if desired.

In the embodiment illustrated, paper supply 13 includes a roll of paper 19 which is rotatively mounted on a pair of spaced apart, inclined arms 21 that extend upwardly and rearwardly from base plate 17. The paper is preferably a single layer of material, such as 40-55 pound brown craft paper, although paper of other weights and/or types can be used, including paper stock having more than one layer of material. Alternatively, if desired, instead of a roll, the paper can be supplied in another form, e.g. fan-folded in a box.

Paper 19 is wound about a cylindrical core 22 to form a roll 23, and the end portions of the core rest in semi-circular journals 24 at the outer ends of support arms 21. If desired, a handle or knob 25 can be attached to one or both ends of the core to facilitate handling of the roll during installation and removal.

Crumpling head 16 and forming unit 14 are mounted above paper supply 13 on a column or post 26 which extends upwardly from base plate 17. In the embodiment illustrated, the column is inclined in a forward direction, and formed in two sections 27, 28 which telescope together to permit the height of the crumpling head and the forming unit to be adjusted. A crosspin 29 is inserted into aligned openings 31 in the two sections to lock the column at a desired height. Alternatively, a column of fixed length could be employed, if desired.

Forming unit 14 comprises an arcuately curved bar 32 about which paper 19 is trained as it is fed from roll 23 to crumpling head 16. The forming bar is mounted on an arm 33 which extends rearwardly and upwardly from crumpling head 16, and it imparts a lateral curvature to the paper, thereby drawing the edges of the paper closer together as it is fed into the crumpling head.

Crumpling head 16 is enclosed within a housing 36 having a base plate 37 which is affixed to a mounting plate 38 at the upper end of column 26. A pair of generally parallel, upright mounting plates 39, 41 are affixed to base plate 37, with cross bars 42 extending between upper portions of the mounting plates for stability. The housing also has a cover 43 with side walls 44, 45 and sloping front and rear walls 46, 47.

An ON/OFF switch 48 and an emergency switch 49 are mounted on side wall 45 for controlling the operation of the machine and shutting down the machine in the event of a malfunction. In one presently preferred embodiment, the OF/OFF switch is a rotary switch and the emergency switch is a pushbutton switch, but other suitable types of switches can be employed, if desired. A panel light 51 on side wall 45 indicates when the machine operating or ready for operation.

A paper inlet slot 52 and a discharge slot 53 are formed between cover 43 and base plate 37, with the discharge slot facing generally in a downward direction to direct the crumpled paper emerging from the machine down toward the bench or surface on which it is mounted.

Within housing 36, the crumpling head includes a folding and feeding mechanism 56 and a cutting mechanism 57. The folding and feeding mechanism comprises a lower drive unit 58 and an upper drive unit 59 which crease the paper and feed it through the machine.

Lower drive unit 58 has a pair of side plates 61, 62 which are affixed to base plate 37, with a pair of rotatively mounted shafts 63, 64 extending between the side plates. A drive pulley 65 is affixed to the outer end of shaft 63, and a plurality of feed belts 66 are trained about belt wheels 67 which are affixed to the shafts and spaced apart between the side plates. The feed belts extend through longitudinally extending slotted openings 68 in a guide plate 69 positioned between the side plates.

Upper drive unit 59 is similar to lower drive unit 58, and has a pair of side plates 71, 72 which are mounted on lower side plates 61, 62, with a pair of rotatively mounted shafts 73, 74 extending between them. A drive pulley 76 is affixed to the outer end of shaft 73, and a plurality of feed belts 77 are trained about belt wheels 78 which are affixed to the shafts and spaced apart between the side plates. Feed belts 77 extend through longitudinally extending slotted openings 81 in a guide plate 82 positioned between the side plates, with the lower runs of belts 77 in facing engagement with the upper runs of belts 66.

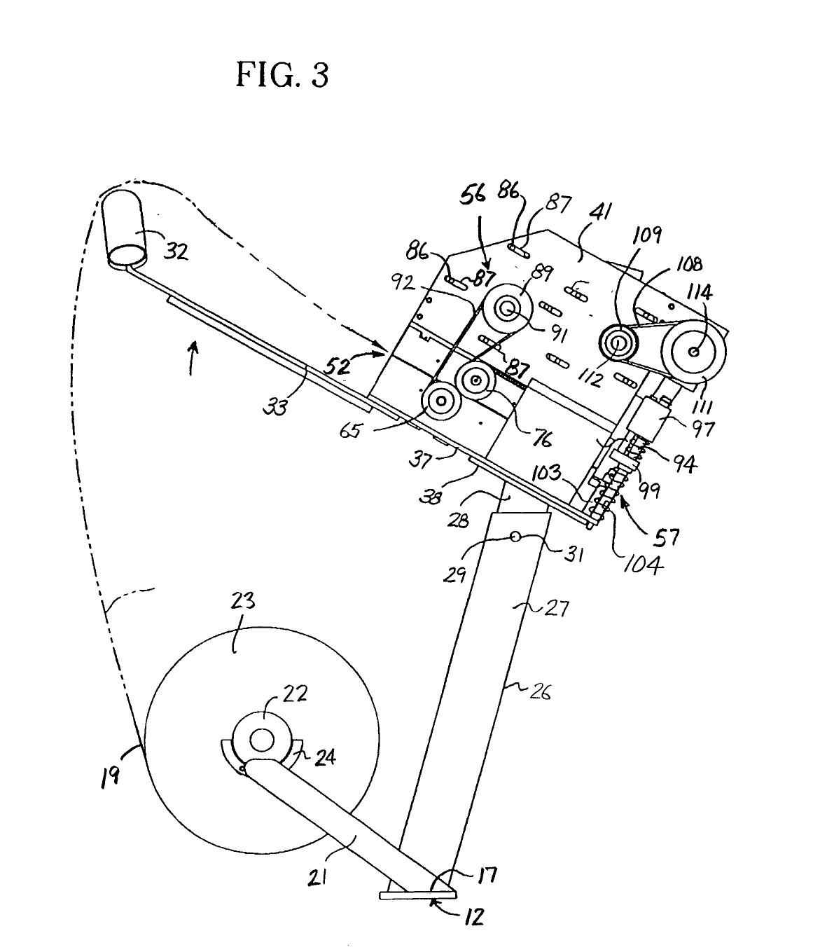

Feed belts, 66, 77 are driven by a drive motor 84 which is positioned between upright plates 39, 41. The motor is affixed to plate 39 by bolts 86 which pass through slotted openings 87 in the plate and are received in internally threaded bosses 88 on the motor housing. A drive pulley 89 is mounted on the output shaft 91 of the motor, and a drive belt 92 is trained about that pulley and about pulleys 65, 76 on shafts 63, 73, with the inner surface 92a of the belt engaging pulley 65 and the outer surface 92b engaging pulley 76. This causes shafts 63, 73 to rotate in opposite directions and the confronting surfaces of feed belts 66, 76 to travel in the same direction. Thus, for example, if drive pulley 89 rotates in a clockwise direction, as viewed in FIG. 3, then pulley 65 also rotates in a clockwise direction and pulley 76 rotates in a counterclockwise direction, with the upper run of belts 66 and the lower runs of belts 77 travelling in a forward direction to draw the paper 19 from supply 13.

Shaft 73 has a threaded extension 94 on which a crank handle, knob or the like (not shown) can be mounted for manually rotating the shaft to advance the feed belts 66, 77 when paper is first fed into the machine or to clear a paper jam.

Cutting mechanism 57 includes a knife blade 96 mounted in a support block or holder 97 that slides up and down on a pair of vertically extending guide rods 98 affixed to base plate 37. A compression bar 99 is slidably mounted on the rods beneath blade holder 97 and has a slot 101 through which the blade can pass. A blade receiving block 102 is affixed to the base plate and has a slot 103 for receiving the blade when it is in a down or advanced position. Compression springs 104 are mounted on guide rods 98 between knife holder 97 and compression bar 99 and also between the compression bar and blade receiving block 102. These springs urge the blade in an upward direction toward its retracted position.

The knife blade is moved in reciprocal fashion between its advanced and retracted positions by a crank mechanism which is driven by a second motor 106 mounted on upright support plate 39. This mechanism includes a crank 107 driven by a belt 108 trained about pulleys 109, 111 affixed to the motor shaft 112 and to the input shaft 114 of the crank. A linkage arm 116 is rotatively mounted on crank pin 117 and pivotally connected to knife holder 97. As the crank rotates, the lower end of linkage arm 116 travels up and down, thereby driving the blade between its advanced and retracted positions.

Paper which has been crumpled paper passes between compression bar 99 and block 102 as it exits from the machine. Upon downward movement of the knife blade, the compression bar is urged into holding engagement with the paper through the springs above it, and upon upward movement of the knife blade, the springs below the compression bar urge the bar in an upward direction to release the paper. The bar is further lifted by a return link 118 which is affixed to the bar and slidably connected to knife holder 97.

The position of knife blade 96 is monitored by a limit switch 119 which is mounted on the base plate 37 in vertical alignment with a protrusion 121 on blade holder 97 and is actuated or closed when the blade is in its advanced or down position.

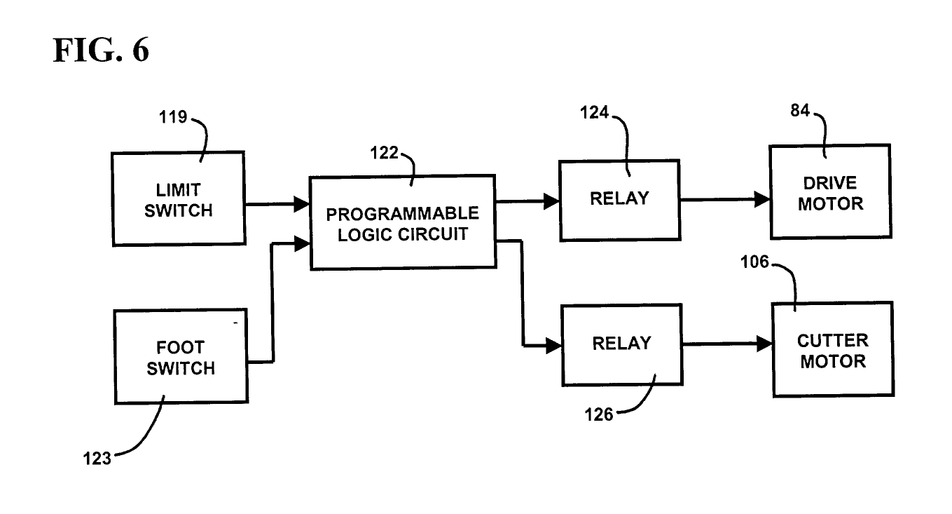

As illustrated in FIG. 6, operation of the machine is controlled by a programmable logic controller (PLC) 122 which responds to the limit switch and to a foot switch 123 to control drive motor 84 and cutter motor 106 through relays 124, 126.

Depression of the foot switch is detected by the PLC which activates relay 124 to turn on drive motor 84 and advance belts 66, 77 to feed paper through the machine. When the foot switch is released, the PLC deactivates relay 124 and activates relay 126, turning off drive motor 84 and turning on cutter motor 106. When knife blade 96 reaches the end of its descent, limit switch 119 is actuated, and the PLC deactivates relay 126 to turn off the cutter motor, with the rotational momentum of the motor returning the blade to its raised position.

Repeated depression and release of the foot switch causes the paper to be sequentially advanced and cut, with the length of the cut material being determined by the amount of time the switch is depressed. Thus, the length of the material can be varied simply by depressing the foot switch for a longer or shorter period of time.

As the paper 19 from roll 23 travels about forming bar 32, the bar imparts a lateral curvature to the paper and thereby draws the edges of the paper closer together. As the curved paper passes between belts 66, 77, it is crumpled in random fashion to produce a sheet-like cushioning material or dunnage which is narrower and thicker than the original paper stock. In one current embodiment, for example, the paper is formed and crushed from an initial width of about 24-30 inches to a final width of about 62-12 inches. However, it will be understood that the paper can be supplied in desired initial width and crushed or crumpled to other final widths.

It is apparent from the foregoing that a new and improved machine and method for converting paper stock to cushioning material or dunnage have been provided. While only certain presently preferred embodiments have been described in detail, as will be apparent to those familiar with the art, certain changes and modifications can be made without departing from the scope of the invention as defined by the following claims.

1. A machine for converting paper stock into cushioning material or dunnage, comprising: a base adapted to be mounted on a bench top, a continuous supply of paper, an arcuately curved forming bar, and a crumpling head having feed belts with confronting surfaces for drawing paper from the supply across the forming bar to impart a lateral curvature to the paper and then randomly crumpling the curved paper as it passes between them to form the cushioning material.

2. The machine of claim 1 wherein the supply of paper comprises a roll of paper which is rotatively mounted on the base beneath the crumpling head.

3. A method of converting paper stock to cushioning material or dunnage, comprising the steps of: withdrawing paper from a supply, passing the paper about an arcuately curved forming bar to impart a lateral curvature to the paper, and passing the curved paper between confronting surfaces of feed belts to crumple the paper and thereby form the cushioning material.

4. The method of claim 3 wherein the paper is withdrawn from the supply by the feed belts.

5. A machine for converting paper stock to cushioning material, comprising: a base adapted to be mounted on a bench, a pair of support arms extending rearwardly of the base, a roll of paper rotatively mounted on the support arms, a column which extends upwardly from the base, a crumpling head mounted on the column above the roll, an arcuately curved forming bar mounted rearwardly of the crumpling head, and means for feeding paper from the roll around the forming bar to the crumpling head.

6. The machine of claim 5 wherein the column on which the crumpling head is mounted is forwardly inclined.

7. The machine of claim 5 wherein the roll of paper includes a cylindrical core on which the paper is wound, and end portions of the core rest in semicircular journals on the support arms.

8. The machine of claim 5 wherein the means for feeding paper comprises a pair of belts within the crumpling head having confronting surfaces which engage the paper to draw it from the roll and to crumple it in random fashion.

9. A machine for converting paper stock to cushioning material, comprising: feed belts having confronting surfaces for feeding paper through the machine and crumpling the paper as it passes between them, a knife blade movable between retracted and advanced positions for cutting off the paper after it has been crumpled, a drive motor operatively connected to the feed belts, a second motor for moving the knife blade between its retracted and advanced positions, and means for alternately actuating the drive motor and the second motor to advance the paper and cut it off.

10. The machine of claim 9 wherein the means for actuating the motors comprises a foot switch, a limit switch for determining when the knife blade reaches its advanced position, and logic circuitry responsive to the foot switch and to the limit switch for actuating the drive motor when the foot switch is depressed, actuating the knife blade motor when the foot switch is released, and deactuating the knife blade motor when the knife blade has reached its advanced position.

11. A method of converting paper stock to cushioning material, comprising the steps of: feeding and crumpling paper with a plurality of feed belts having confronting surfaces between which the paper passes, and advancing a knife blade from a retracted position to an advanced position to cut off the paper after it has been crumpled.

12. The method of claim 11 wherein feed belts are actuated and deactuated in response to depression and release of a foot switch, the knife blade is advanced in response to release of the foot switch.

13. The method of claim 12 further including the steps of actuating a limit switch when the knife blade reaches its advanced position, and deactuating a motor which drives the knife blade upon actuation of the limit switch.
